(19) United States
(12) Patent Application Publication
(10) Pub. No.: US 2006/0249924 A1
(43) Pub. Date: Nov. 9, 2006

(54) Molded running board

(76) Inventors: Bradford D. Armstrong, Barrie (CA); Rudolf A. Schrempf, Brampton (CA)

Correspondence Address: Mr. Robin W. Asher;Clark Hill PLC, Suite 3500, 500 Woodward Avenue, Detroit, MI, 48226-3435, US

(21) Appl. No.: 11/399,075

(22) Filed: Apr. 6, 2006

Related U.S. Application Data
(60) Provisional application No. 60/679,053, filed on May 9, 2005.

(51) Int. Cl. B60R 3/00

(52) U.S. Cl. 280/163

(57) ABSTRACT

A molded running board is fabricated from a moldable material such as thermoplastic or the like and includes a main body with a lower surface, having a stiffening structure, and an upper surface to which one or more trim pieces can be attached. The main body has at least two mount members which are metal inserts molded in place with the main body, the mount members including a portion which extends beyond the main body for use to attach the running board to a vehicle. By altering the finish of the main body and/or the trim pieces, a wide variety of cosmetic appearances of the running board can be obtained without requiring different molds for the main body. Also, by standardizing the location and configuration of the portion of the mount members, the running board can be attached to different vehicles by employing suitable adaptor hardware to connect the mount members to the vehicle, again without requiring different molds for the main body.

### RELATED APPLICATION

This patent application claims priority to and all the benefits of U.S. Provisional Patent Application No. 60/679,053 filed on May 9, 2005.

### BACKGROUND OF THE INVENTION

1. Field of the Invention

The present invention relates to a running board for vehicles. More specifically, the present invention relates to a running board fabricated through a molding process.

2. Description of the Related Art

Running boards are commonly provided on trucks, SUVs and the like for cosmetic and functional reasons. Cosmetically, a running board can improve the looks of the vehicle to which they are attached, while functionally, they can ease the task of entering and exiting the vehicle.

Until recently, running boards were fabricated from either extruded metal pieces or metal tubes, which would often have formed end caps or inwardly curved ends to improve the cosmetic appearance of the running boards.

Problems exist with metal running boards in that they are relatively heavy and add undesired weight to the vehicle, depending upon the metal from which they are fabricated, they can be susceptible to corrosion and, generally, they are relatively expensive to fabricate.

More recently, running boards have been fabricated by compression or injection molding thermoplastic materials, such as glass fiber reinforced polypropylene. By molding the running boards from thermoplastic, the undesired weight and possible corrosion problems associated with metal running boards can be avoided and a wider range of designs can be obtained than can easily be obtained from metal.

However, problems also exist with molded running boards in that the molds for such running boards are relatively expensive to fabricate. Thus, each different design, desired for cosmetic appearance and/or required in order for the running board to be mounted to the target vehicle, requires a new mold.

### SUMMARY OF THE INVENTION

It is an object of the present invention to provide a molded novel running board for vehicles which obviates or mitigates at least one disadvantage of the prior art.

According to a first aspect of the present invention, there is provided a molded running board, including: a main body formed by molding a thermoplastic material, the main body including a lower surface having a stiffening structure to inhibit undesired deflection of the running board, an upper surface to receive at least one trim piece and the main body including at least two mounting members molded in place in the main body and each mounting member extending transversely across the main body and extending from the main body to assist in attaching the running board to a vehicle; and at least one trim piece being attachable to the upper surface of the main body to alter the appearance of the running board.

According to another aspect of the present invention, there is provided running board for a vehicle, comprising: an elongate main body molded from a fiber reinforced thermoplastic material and including at least two metal mount members molded into the elongate body and extending laterally across the main body and extending out of one side of the main body; at least two mounting adapters, each mounting adapter including one portion for attaching the mounting adapter to a respective one of the at least two metal mount members; and at least one trim piece, formed from a material other than the fiber reinforced thermoplastic of the main body and having a cosmetic finish which differs from the finish of the main body, the at least one trim piece being attached to the main body.

The present invention provides a molded running board which is fabricated from a moldable material, such as fiber reinforced thermoplastic or the like, which includes a main body with a lower surface, having a stiffening structure, and an upper surface to which one or more trim pieces can be attached. The main body also has at least two mount members which are metal inserts molded in place with the main body, the mount members including a portion which extends beyond the main body for use to attach the running board to a vehicle. By altering the finish of the main body and/or the trim pieces, a wide variety of cosmetic appearances of the running board can be obtained without requiring different molds for the main body. Also, by standardizing the location and configuration of the portion of the mount members, the running board can be attached to different vehicles by employing suitable adaptor hardware to connect the mount members to the vehicle, again without requiring different molds for the main body.

### BRIEF DESCRIPTION OF THE DRAWINGS

Preferred embodiments of the present invention will now be described, by way of example only, with reference to the attached Figures, wherein:

FIG. 1 shows a top and side exploded perspective view of a running board in accordance with the present invention;

FIG. 2 shows a bottom and side perspective view of the running board of FIG. 1;

FIG. 3 shows a perspective view of a mount adapter to attach the running board of FIG. 1 to a vehicle;

FIG. 4 shows a perspective view of a portion of the underside of a main body of the running board of FIG. 1; and

FIG. 5 shows a perspective view of the topside of the portion of the main body of FIG. 4.

### DETAILED DESCRIPTION OF THE PREFERRED EMBODIMENT

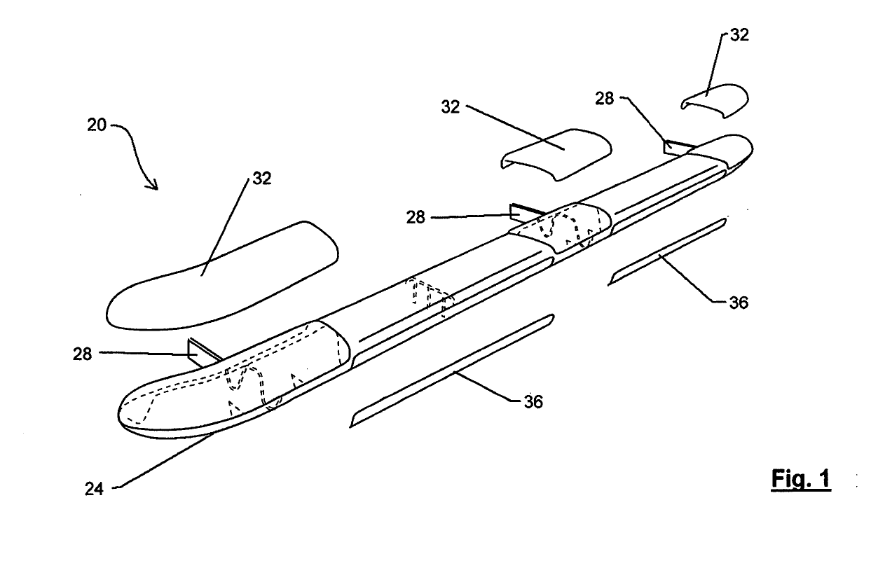

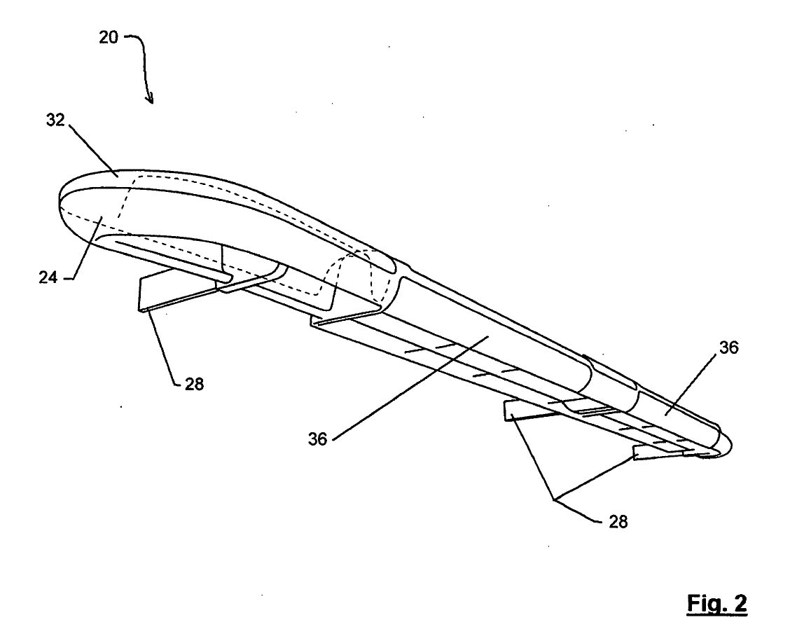

A running board, in accordance with the present invention, is indicated generally at 20 in FIGS. 1 and 2. Running board 20 is preferably fabricated of a suitable moldable thermoplastic material such as glass fiber reinforced polypropylene. As will be apparent, running board 20 can be fabricated using a variety of known molding techniques, including injection molding or compression molding.

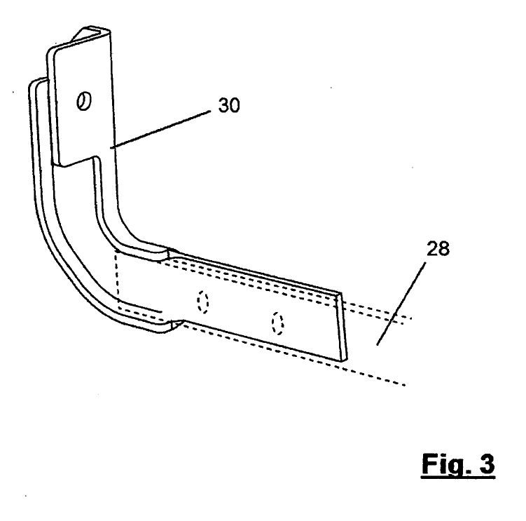

Running board 20 comprises a main body 24 that includes at least two mount members 28, and in the illustrated embodiment three, which are integrally formed with main body 24. Mount members 28 provide standardized connection points for mounting running board 20 to a variety of vehicles. Specifically, mount members 28 are preferably in standardized locations on running board 20 and have a standard size, shape, orientation, etc. The manufacturer of a vehicle need only design a suitable mounting adapter 30, an example of which is shown in FIG. 3, to connect to the structure of the vehicle and to mount member 28. Preferably, mount members 28 are steel plate inserts, of appropriate shape, which are loaded into the mold in which running board 20 is molded and are thus molded in place when running board 24 is fabricated.

Running board 24 further includes one or more upper surface trim pieces 32 and/or one or more front trim pieces 36 which are attached to main body 24 to alter the cosmetic appearance of running board 20. To obtain a desired cosmetic appearance of running board 20, upper surface trim pieces 32 and/or front trim pieces 36 can have applied or molded finishes which differ from the finish of main body 24. Specifically, trim pieces 32 and/or trim pieces 36 can be painted or molded a different color than main body 24.

Further, in one embodiment, main body 24 can be molded with a rough, traction-enhancing upper surface while trim pieces 32 and/or trim pieces 36 are molded with smooth surfaces. Alternatively, main body 24 can be molded with a smooth upper surface and upper trim pieces 32 can be fabricated with a traction enhancing surface.

In one possible configuration, main body 24 will be molded in color or painted a black or dark gray color and trim pieces 32 and/or trim pieces 36 can be painted to match the vehicle's body color. In another possible configuration, main body 24 will be painted to match the vehicle's body color and trim pieces 32 and/or trim pieces 36 can be painted a complementary color.

It is also contemplated that trim pieces 32 and/or trim pieces 36 can be fabricated from a different material than main body 24 and, in fact, trim pieces 32 and/or 36 need not be molded and can instead be stamped metal, etc. Accordingly, trim pieces 32 and/or trim pieces 36 can be chrome or stainless steel or alloy, etc. It is further contemplated that trim pieces 32 and/or 36 can be fabricated from translucent or transparent materials such as acrylic or polycarbonate and light emitting elements such as LEDs or light bulbs can be mounted between main body 24 and trim pieces 32 or 36 to illuminate trim pieces 32 and/or 36. In such a case, one or more of trim pieces 32 or 36 can be painted, or otherwise opaqued, over most of its surface and an insert logo, for example, identifying the manufacturer and/or model of the vehicle, can be left translucent to be illuminated by the light emitting elements, or the inverse arrangement of opaque for the logo and translucent for the rest of the trim piece can be employed.

In addition to allowing for running board 20 to be assembled with trim pieces 32 and/or 36 being fabricated from different materials, having different colors and/or finished and surfaces, it is also contemplated that the shapes of trim pieces 32 and/or 36 can be varied. In particular, it is contemplated that by employing upper surface trim pieces 32 with different profiles, the appearance of running board 20 can be significantly changed, without requiring a different mold for main body 24.

As an example, the upper surface of upper trim piece 32 can be shaped in a variety of manners such as generally rounded, as shown in FIG. 1, or it can be flat or generally planar and inclined toward or away from the vehicle body, etc. In this manner, a wide variety of cosmetic appearances can be obtained for running board 20 merely by changing trim pieces 32 and/or 36.

Trim pieces 32 and/or 36 can be attached to main body 24 in any suitable manner including, without limitation, adhesive bonding, sonic welding, mechanical fasteners and/or press-to-fit connectors, such as resilient snap arms (not shown) on trim pieces 32 or 36 and corresponding slots (not shown) in main body 24.

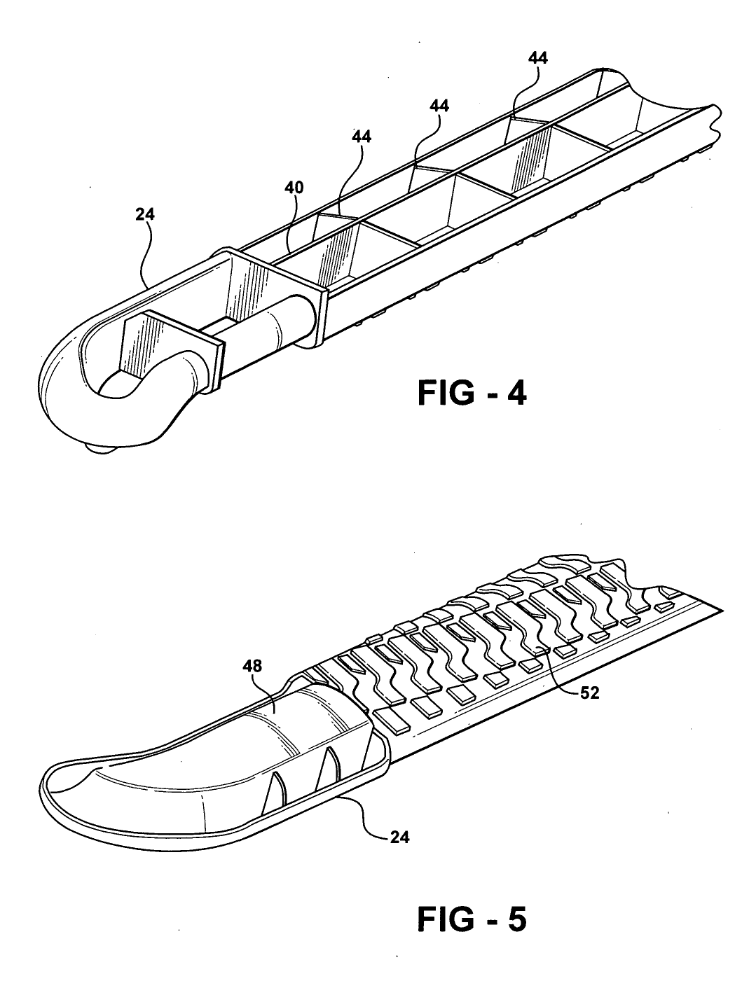

As shown in FIG. 4, main body 24 is preferably molded with at least one longitudinal web 40 and a plurality of lateral webs 44 which are formed into the underside of main body 24 to stiffen and/or otherwise strengthen main body 24. While such a configuration of lateral and longitudinal webs is presently referred, it will be apparent to those of skill in the art that a variety of other stiffening structures can be formed on the underside of main body 24, such as stiffening ribs, etc. and such other structures are also intended to be within the scope of the present invention. Mount members 28, not shown in FIG. 4, also serve to stiffen main body 24 as they extend across main body 24.

FIG. 5 shows one possible structure 48 to receive upper surface trim piece 32. As illustrated, main body 24 includes upwardly extending structure 48 which includes a substantially planar upper surface to support trim piece 32 and which also serves to stiffen main body 24. As is also shown in FIG. 5, as an alternative to the smooth surface between trim pieces 32 shown in FIGS. 1 and 2, main body 24 can have a molded surface 52 to provide traction surfaces (as illustrated) or other desired surface features.

The present invention provides an advantageous molded running board which is fabricated from a moldable material such as thermoplastic or the like. The running board includes a main body with a lower surface, having a stiffening structure, and an upper surface to which one or more trim pieces can be attached. The main body also has at least two mount members which are metal inserts molded in place with the main body, the mount members including a portion which extends beyond the main body for use to attach the running board to a vehicle. By altering the finish of the main body and/or the trim pieces, a wide variety of cosmetic appearances of the running board can be obtained without requiring different molds for the main body. Also, by standardizing the location and configuration of the portion of the mount members, the running board can be attached to different vehicles by employing suitable adaptor hardware to connect the mount members to the vehicle, again without requiring different molds for the main body.

The above-described embodiments of the invention are intended to be examples of the present invention and alterations and modifications may be effected thereto, by those of skill in the art, without departing from the scope of the invention which is defined solely by the claims appended hereto.

What is claimed is:

1. A molded running board, including:
a main body formed by molding a thermoplastic material, the main body including a lower surface having a stiffening structure to inhibit undesired deflection of the running board, an upper surface to receive at least one trim piece and the main body including at least two mounting members molded in place in the main body and each mounting member extending transversely across the main body and extending from the main body to assist in attaching the running board to a vehicle; and
at least one trim piece being attachable to the upper surface of the main body to alter the appearance of the running board.

2. The molded running board of claim 1 wherein the at least one trim piece is fabricated from a different material than the main body.

3. The molded running board of claim 1 wherein the at least one trim piece and the main body have different finish applied to them.

4. The molded running board of claim 1 wherein the thermoplastic material is fiber reinforced.

5. The molded running board of claim 1 including at least one upper surface trim piece and one front surface trim piece each of which is attachable to the upper surface of the main body.

6. The molded running board of claim 1 including at least two trim pieces attached to the upper surface of the main body.

7. The molded running board of claim 6 wherein the main body includes a molded traction enhancing surface on the upper surface of the main body, the traction enhancing surface being located between the attached trim pieces.

8. The molded running board of claim 6 wherein the upper surface of the main body includes a substantially smooth surface between the attached trim pieces and the attached trim pieces include a traction enhancing surface.

9. The molded running board of claim 1 wherein the at least one trim piece includes a portion through which light can pass and wherein the running board further includes at least one light source between the main body and the trim piece to illuminate the portion.

10. A running board for a vehicle, comprising:
an elongate main body molded from a fiber reinforced thermoplastic material and including at least two metal mount members molded into the elongate body and extending laterally across the main body and extending out of one side of the main body;
at least two mounting adapters, each mounting adapter including one portion for attaching the mounting adapter to a suitable structure of the vehicle and a second portion for attaching the mounting adapter to a respective one of the at least two metal mount members; and
at least one trim piece, formed from a material other than the fiber reinforced thermoplastic of the main body and having a cosmetic finish which differs from the finish of the main body, the at least one trim piece being attached to the main body.
